(19) United States
(12) Patent Application Publication
(10) Pub. No.: US 2009/0252211 A1
(43) Pub. Date: Oct. 8, 2009

(54) METHOD AND DEVICE FOR ESTIMATING SPEED OF WIRELESS TERMINAL

(75) Inventor: Calvin Wang, Beijing (CN)

Correspondence Address: J C PATENTS, INC., 4 VENTURE, SUITE 250, IRVINE, CA, 92618, US

(73) Assignee: VIA Technologies, Inc., Taipei Hsien (TW)

(21) Appl. No.: 12/167,450

(22) Filed: Jul. 3, 2008

(30) Foreign Application Priority Data
Apr. 3, 2008 (CN) 200810090570.9

(51) Int. Cl. H04B 17/00

(52) U.S. Cl. 375/225

(57) ABSTRACT

A speed estimation device applicable to an orthogonal frequency division multiplex (OFDM) system is provided. The speed estimation device receives a plurality of channel response information signals from an OFDM symbol and obtains a speed estimation result according to a sampling interval, the speed estimation device. The speed estimation device comprises a correlator, a statistical module, and a comparator. The correlator performs a correlation operation on the plurality of channel response information signals corresponding to sub-carriers with a time domain interval being the sampling interval to obtain a plurality of correlation result information signals. The statistical module connected to the correlator performs a statistical operation on the plurality of correlation result information signals to obtain a statistical correlation result information signal. The comparator connected to the statistical module compares the statistical correlation result information signal with a first threshold according to the first threshold to obtain the speed estimation result.

### CROSS-REFERENCE TO RELATED APPLICATION

This application claims the priority benefit of China application serial no. 200810090570.9, filed on Apr. 3, 2008. The entirety of the above-mentioned patent application is hereby incorporated by reference herein and made a part of this specification.

### BACKGROUND OF THE INVENTION

1. Field of the Invention

The present invention generally relates to an orthogonal frequency division transmission system, in particular, to a method and device for estimating speed of wireless terminal in an orthogonal frequency division communication system.

2. Description of Related Art

In a digital communication wireless system for transmitting information like voices and videos, orthogonal frequency division multiplex (OFDM) technology has already been widely utilized. For example, digital audio broadcasting (DAB) system, digital video broadcast-terrestrial/handheld (DVB-T/H), and the like are used under the wireless channels with frequency selective fading.

In the above wireless communication systems, one of the key techniques is receiving data when the wireless terminal is in movement, and especially in a high-speed movement, as the variation of the vehicle travelling speed or the terminal moving speed may exhibit Doppler effect and induce frequency variation. Therefore, the movement of a receiving terminal relative to a transmitting end may lead to a Doppler shift. The maximum Doppler shift is in direct proportion to the speed of the relative movement, i.e., fₘₐₓ=υ·f_{c}/c, where fₘₐₓ is the maximum Doppler shift, υ is a moving speed of a wireless terminal, and f_{c} is a carrier speed of a mobile terminal. The maximum Doppler shift determines the greatest signal variance adjustable at the receiving terminal, and thus has a significant impact on the performance of a received signal.

However, different moving speed of the receiving terminal may result in different maximum Doppler shifts. If the moving speed of the receiving terminal can be accurately estimated, the moving speed can be classified into a fast mode or a slow mode, and different schemes can be adopted directing to the corresponding channel estimation, thus improving the receiving efficiency.

However, in the current digital wireless communication systems, no fast and effective method for estimating the moving speed of a wireless terminal is provided, or the same purpose is fulfilled by taking up plenty of the storage space or through highly complicated operations. For example, one method is performing correlation on estimated values of sampling point channels at a certain length for all the pilot frequencies, so as to obtain an estimated value of the moving speed of the wireless terminal. However, this method is applicable at a low operating speed, and meanwhile requires a large capacity of storage to store the pilot frequency values.

Therefore, in order to solve the above problems, it is in urgent need of solution to provide a method of high performance for estimating the moving speed of wireless terminal, and compensating the effects induced by the moving speed of wireless terminal. Meanwhile, to further reduce the cost and improve the operating speed, the required method for estimating the moving speed of wireless terminal should be advantageous in having a higher operating speed and occupying less storage space.

### SUMMARY OF THE INVENTION

Accordingly, the present invention is directed to an accurate and effective scheme for estimating speed of wireless terminal, so as to obtain a desired channel estimation effect.

The present invention provides a speed estimation device applicable to an orthogonal frequency division multiplex (OFDM) system, for receiving a plurality of channel response information signals from OFDM symbols and obtaining a speed estimation result according to a sampling interval. The speed estimation device includes a correlator for performing a correlation operation on a plurality of channel response information signals corresponding to sub-carriers with a time domain interval being the sampling interval, so as to obtain a plurality of correlation result information signals, a statistical module connected to the correlator and used for performing a statistical operation on the plurality of correlation result information signals, so as to obtain a statistical correlation result information signal, and a comparator connected to the statistical module and used for comparing the statistical correlation result information signal with a first threshold, so as to obtain the speed estimation result.

The present invention further provides a speed estimation method applicable to an orthogonal frequency division multiplex (OFDM) system, for receiving a plurality of channel response information signals and obtaining a speed estimation result according to a sampling interval. The method includes performing a correlation operation on two sub-carriers selected with a time domain interval being the sampling interval, so as to obtain a plurality of correlation result information signals, performing a statistical operation on the plurality of correlation result information signals, so as to obtain a statistical correlation result information signal, and comparing the statistical correlation result information signals with a first threshold, so as to obtain the speed estimation result.

The present invention further provides an orthogonal frequency division multiplex (OFDM) receiver. The receiver includes a signal receiving device for receiving a plurality of OFDM symbols and performing frequency compensation on the received plurality of OFDM symbols, so as to output a plurality of channel response information signals, a speed estimation device for receiving the plurality of channel response information signals output by the signal receiving device, and performing speed estimation according to a sampling interval, so as to output a speed estimation result, and a channel estimation device connected to the speed estimation device, for receiving the speed estimation result and completing the channel estimation.

The speed estimation device and method provided by the present invention may significantly reduce the storage space required during the estimation process and greatly improve the operating speed, thereby eliminating the defects in the conventional OFDM system estimation technique.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an orthogonal frequency division multiplex (OFDM) receiver according to an embodiment of the present invention.

FIG. 2A is a block diagram of a speed estimation device according to an embodiment of the present invention.

FIG. 2B is a block diagram of a speed estimation device according to an embodiment of the present invention.

FIG. 2C is a block diagram of a speed estimation device according to an embodiment of the present invention.

FIG. 2D is a block diagram of a filter circuit in a speed estimation device according to an embodiment of the present invention.

FIG. 3 is a schematic view showing a speed estimation device performing a correlation operation on channel response information signals according to an embodiment of the present invention.

FIG. 4A is a flow chart of a speed estimation method according to an embodiment of the present invention.

FIG. 4B is a flow chart of a speed estimation method according to an embodiment of the present invention.

FIG. 4C is a flow chart of a speed estimation method according to an embodiment of the present invention.

FIG. 5 is a schematic view showing changes of time correlation function statistical values of a DVB-T in a 2 k mode according to an embodiment of the present invention.

FIG. 6 is a block diagram of a receiver in an OFDM system according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

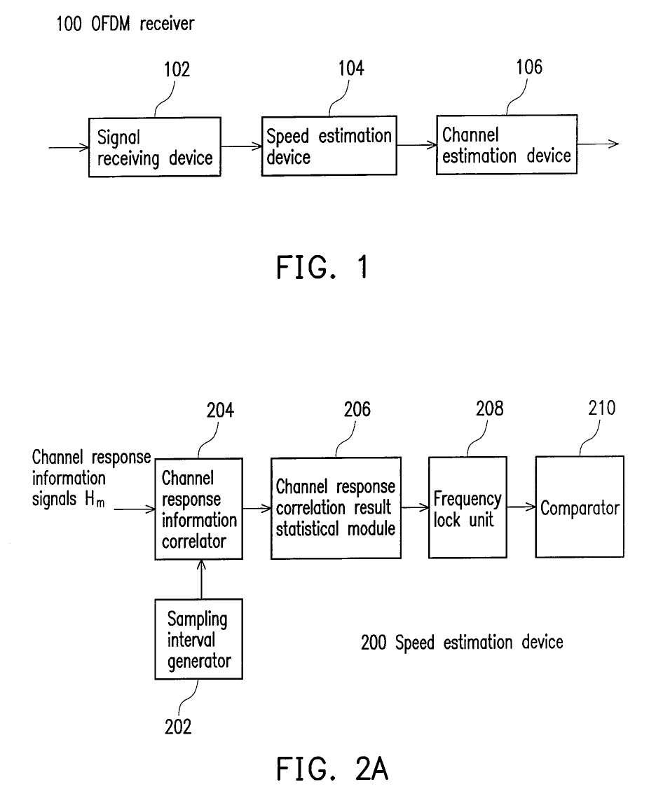

FIG. 1 is a schematic view of an orthogonal frequency division multiplex (OFDM) receiver with a speed estimation device. The OFDM receiver 100 includes a signal receiving device 102, a speed estimation device 104, and a channel estimation device 106. After receiving a radio signal, the signal receiving device 102 converts the received radio frequency (RF) analog signal into a digital signal, and filters the signal to reduce noises and interference signals. In this embodiment, the signal receiving device 102 may perform automatic frequency control on the converted digital signal, and meanwhile further adjust the frequency of the received signal through a Fourier transformer, signal capturer, loop filter, offset compensator, and so on, so as to make the working frequency of the system remain a stably reduced aberration and thus enhance the anti-interference capacity. The signal receiving device 102 outputs a plurality of channel response information signals Hₘ, and the channel response information signals Hₘ are correlated to sub-carriers in a received OFDM symbol and pilot frequency information. The speed estimation device 104 is connected to the signal receiving device 102 for receiving the channel response information signals, and performing a correlation operation and a statistical operation on the plurality of channel response information signals Hₘ, so as to obtain a speed estimation result. The speed estimation result may include a fast mode and a slow mode. The channel estimation device 106 receives the speed estimation result generated by the speed estimation device 104, and adopts channel estimation schemes corresponding to different speed modes, so as to obtain an optimal channel estimation result.

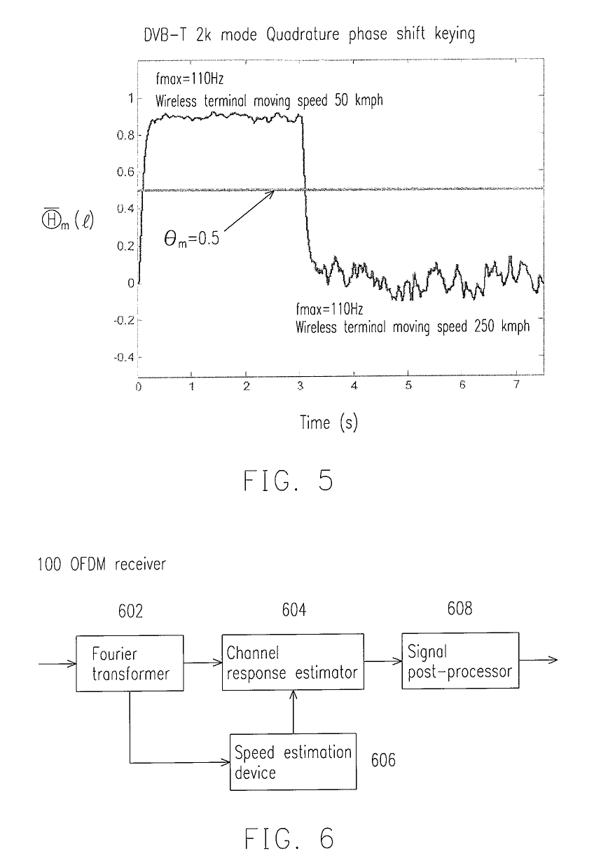

The OFDM receiver of the present invention may also be implemented as shown in FIG. 6. Referring to FIG. 6, the OFDM receiver 100 includes a Fourier transformer 602, a channel response estimator 604, a speed estimation device 606, and a signal post-processor 608. The Fourier transformer 602 performs Fourier transform on the received orthogonal frequency division signals, and as the technique of performing Fourier transform on the received signals is well-known in the art, the details will not be repeated herein again. Then, the signal transformed by the Fourier transformer 602 is transmitted to the channel response estimator 604 and the speed estimation device 606. The channel response estimator 604 receives the speed estimation result output by the speed estimation device 606, and the speed estimation result includes a fast mode and a slow mode. The channel response estimator 604 selects suitable channel estimation schemes according to different moving speeds of the mobile terminal. In addition, the signal post-processor performs operations such as equalization and decoding on the received signal according to the channel estimation result.

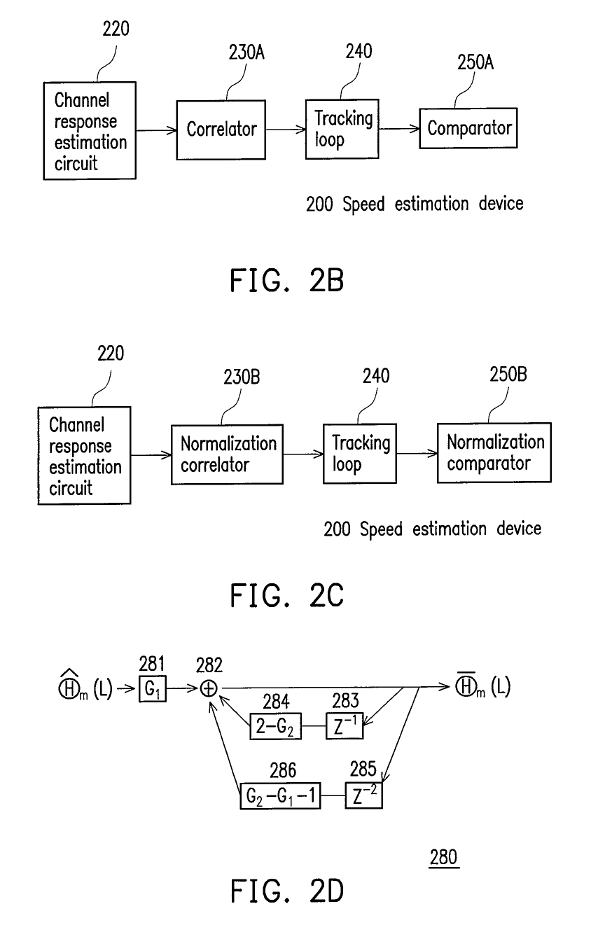

FIG. 2A shows a speed estimation device applicable to an OFDM system. The speed estimation device 200 includes a sampling interval generator 202, a channel response information correlator 204, a channel response correlation result statistical module 206, a frequency lock unit 208, and a comparator 210.

In this embodiment, the speed estimation device is applied in a digital video broadcast-terrestrial/handheld (DVB-T/H). The sampling interval generator 202 determines a sampling interval according to the moving speed, carrier speed, and first-kind zero-order Bessel function supported by the wireless terminal under the working modes of 2 k, 4 k, and 8 k in the DVB-T/H. A formula for calculating the sampling interval is Θ_{Δt}(l)=J₀(2πfₘₐₓlTₛ), where Tₛ is a length of an OFDM symbol, and a threshold is set for the time correlation function Θ_{Δt}(l). When the sampling interval l makes the time correlation function Θ_{Δt}(l) smaller than the threshold for the first time, the l satisfying this condition is considered as the optimal sampling interval. In this embodiment, the sampling interval l is a time domain difference of signals received from the same sub-carrier at different time points by the wireless terminal. The sampling interval l can be calculated based on the J₀(2πfₘₐₓlTₛ) passing the zero point for the first time, or by setting another threshold as an initial estimated value of the time correlation function Θ_{Δt}(l), and then a fine adjustment is performed according to the sampling interval l. For example, in the DVB-T/H, the threshold is set as 0.5. If the speed threshold υ_{c} for the fast mode and the slow mode is 130 kmph, and the carrier frequency f_{c} of the transmitter is 474 MHz, l is 16 in the 2 k mode, 8 in the 4 k mode, and 4 in the 8 k mode. The following estimation process also takes the above settings as an example, but the present invention is not limited thereto. In addition, the 2 k, 4 k, and 8 k working modes of the DVB-T/H represent the number of the sub-carriers in the DVB-T/H, and the above three modes respectively have a different symbol period and guard interval.

It is comprehensible that the sampling interval generator 202 is a calculator or a storage. That is to say, the storage stores parameters calculated by the above rules, and provides the parameters to the channel response information correlator 204.

The channel response information correlator 204 receives the channel response information signals Hₘ and the sampling interval l output by the sampling interval generator 202, and performs a correlation operation on two OFDM symbols of the (kₚ_{ᵢ})^{th} sub-carrier so as to obtain a correlation value. The speed impact on different sub-carriers is the same, so the same correlation operation is performed on sampling symbols at the same position and with the same interval of the previous M consecutive sub-carriers. M is the number of the correlation values of the consecutive sub-carriers that can be stored in the channel response information correlator 204.

The channel response correlation result statistical module 206 performs a statistical operation on an output result of the channel response information correlator 204 according to

$${\hat{Θ}}_{m} ( l ) = \frac{1}{M} {\sum }_{i = 1}^{M} {\hat{H}}_{m} ( {k}_{{p}_{i}} ) \cdot {\hat{H}}_{m + l}^{*} ( {k}_{{p}_{i}} ) ,$$

and obtains a time correlation function statistical value, where Ĥₘ(kₚ_{ᵢ})·Ĥ*ₘ₊ₗ(kₚ_{ᵢ}) is the output result of the channel response information correlator 204. The result is obtained from two symbols through operation, and a statistical operation is required due to large variation. It is comprehensible that the channel response correlation result statistical module 206 may obtain a statistical value through an arithmetic mean method.

The frequency lock unit 208 is connected to the channel response correlation result statistical module 206, for performing frequency lock according to the time correlation function statistical value, so as to obtain an adjusted time correlation function statistical value. In this embodiment, the frequency lock unit 208 is a second-order digital loop filter. FIG. 2D is a schematic view of a loop filter. The design of the filter does not belong to the scope of the present invention, so the details will not be given here. However, those of ordinary skill in the art should understand that any filter capable of achieving the simliar function, for example, a first-order digital loop filter, can also form the frequency lock unit 208.

The comparator 210 receives and compares the adjusted time correlation function statistical value generated from the frequency lock unit 208 with a threshold. The adjusted time correlation function statistical value is considered in a slow mode when being larger than the threshold, and the adjusted time correlation function statistical value is considered in a fast mode when being smaller than the threshold. In this embodiment, the threshold is set as 0.5.

FIG. 2B is a block diagram of a speed estimation device 200 in an OFDM system according to an embodiment of the present invention. The speed estimation device 200 includes a channel response estimation circuit 220, a correlator 230A, a tracking loop 240, and a comparator 250A.

The channel response estimation circuit 220 receives a plurality of OFDM symbols, then generates a plurality of first channel response information signals according to a plurality of first pilot frequency information signals in the i^{th} OFDM symbol, and generates a plurality of second channel response information signals according to a plurality of second pilot frequency information signals in the k^{th} OFDM symbol.

The correlator 230A is coupled to the channel response estimation circuit 220, for receiving the first channel response information signals and the second channel response information signals, so as to generate a correlation value \hat{Θ}ₘ(L) after a correlation operation performed on the first and the second channel response information. The tracking loop 240 is coupled to the correlator 230A, for generating a statistical correlation value Θ̅ₘ(L) after a statistical operation is performed on the correlation value \hat{Θ}ₘ(L). FIG. 2D shows a filter circuit 280 as an implementation of the tracking loop 240, but the present invention is not limited thereto.

The filter circuit 280 includes a first multiplier 281, an adder 282, a first delayer 283, a second multiplier 284, a second delayer 285, and a third multiplier 286. The first multiplier 281 is coupled to an input end of the filter circuit 280, for multiplying the i^{th} correlation value \hat{Θ}ₘ(L) with a first multiplication coefficient G1, so as to generate the i^{th} first multiplication correlation value. The adder 282 is coupled to the first multiplier 281, for receiving the i^{th} first multiplication correlation value.

The first delayer 283 is coupled to the adder 282, for delaying one transmission time of first multiplication correlation value. The second multiplier 284 is coupled to the first delayer 283, for multiplying the i^{th} first multiplication correlation value delayed by a transmission time with a second multiplication coefficient (2−G2), so as to generate the i^{th} second multiplication correlation value.

The second delayer 285 is coupled to the adder 282, for delaying two transmission time of first multiplication correlation value. The third multiplier 286 is coupled to the second delayer 285, for multiplying the i^{th} first multiplication correlation value delayed by two transmission time with a third multiplication coefficient (G2−G1−1), so as to generate the i^{th} third multiplication correlation value.

The second multiplier 284 and the third multiplier 286 are further coupled to the adder 282. That is to say, after receiving the (i+2)^{th} first multiplication correlation value, the adder adds up the (i+1)^{th} second multiplication correlation value, the i^{th} third multiplication correlation value, and the (i+2)^{th} first multiplication correlation value, so as to obtain a statistical correlation value Θ̅ₘ(L), and further transmits the statistical correlation value Θ̅ₘ(L) to an output end of the filter circuit 280.

When applied in a DVB-T/H, the G1 and G2 in the filter circuit 280 may be 0.00005 and 0.015 respectively. Further, the tracking loop 240 may be an averaging circuit or other multi-stage filter circuits. In brief, the implementation of the tracking circuit 240 is not intended to limit the present invention.

The comparator 250A is coupled to the tracking loop 240, for setting a correlation value threshold Θ_{TH}. The comparator 250A compares the correlation value threshold Θ_{TH} with the statistical correlation value Θ̅ₘ(L) to obtain a difference there-between, and further determines whether the status of the channel is in the fast mode or the slow mode according to the difference.

In addition, referring to FIG. 2C, the correlator 230A in FIG. 2B may be a normalization correlator 230B for performing a normalization correlation operation on the first channel response information signals and the second channel response information signals after being collated, so as to obtain a normalized correlation value \hat{Θ}ₘ₋ₙₒᵣ(L). The formula of the normalization correlation operation is as follows:

$${\hat{Θ}}_{m - nor} ( L ) = \frac{Re \{ {\sum }_{i = 1}^{M} [ {\hat{H}}_{m} ( {k}_{{p}_{i}} ) \cdot {\hat{H}}_{m + L}^{*} ( {k}_{{p}_{i}} ) ] \}}{\begin{matrix}\sqrt{{\sum }_{i = 1}^{M} {\hat{H}}_{m} ( {k}_{{p}_{i}} ) \cdot {\hat{H}}_{m}^{*} ( {k}_{{p}_{i}} )} \cdot \\ \sqrt{{\sum }_{i = 1}^{M} {\hat{H}}_{m + L} ( {k}_{{p}_{i}} ) \cdot {\hat{H}}_{m + L}^{*} ( {k}_{{p}_{i}} )}\end{matrix}}$$

The tracking loop 240 receives the normalized correlation value \hat{Θ}ₘ₋ₙₒᵣ(L), and obtains a normalized statistical correlation value Θ̅ₘ₋ₙₒᵣ(L) after a statistical operation is performed on the normalized correlation value \hat{Θ}ₘ₋ₙₒᵣ(L). Similarly, the comparator 250A in FIG. 2B may be a normalization comparator 250B in FIG. 2C, and be changed to set a normalized correlation value threshold Θ_{TH-nor}. The normalization comparator 250B compares the normalized statistical correlation value Θ̅ₘ₋ₙₒᵣ(L) with the normalized correlation value threshold Θ_{TH-nor} to obtain a difference there-between, and further determines whether the status of the channel information is in the fast mode or the slow mode.

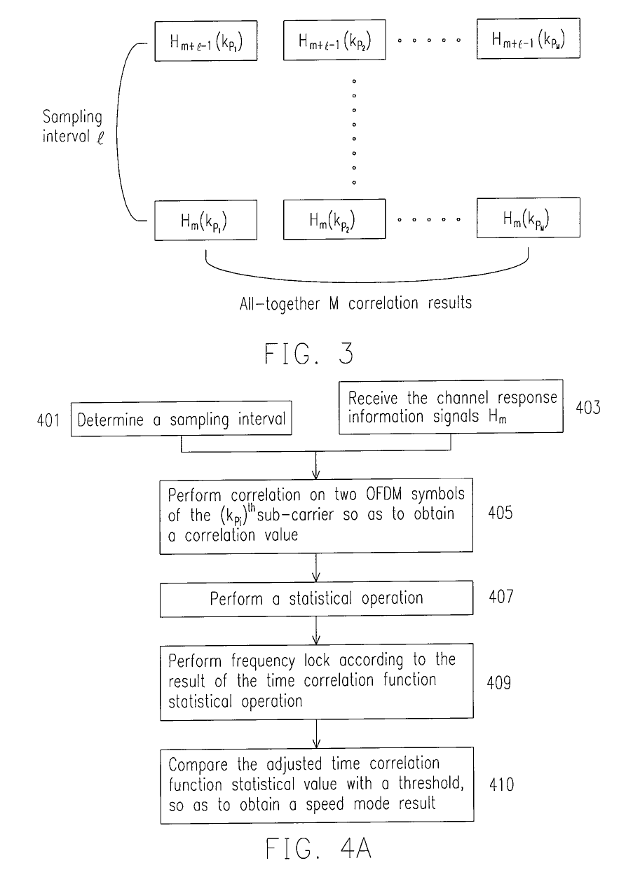

FIG. 3 is a schematic view showing the correlator in FIG. 2A performing an operation on the channel response information. The Hₘ₊ₗ₋₁(kₚ_{ᵢ}) is corresponding to the channel response information signal of the (kₚ_{ᵢ})^{th} sub-carrier in the OFDM system. The correlator performs a correlation operation on the channel response information signals of a pair of sub-carriers with a sampling interval of l, for example, Hₘ₊ₗ₋₁(kₚ_{ᵢ}) and Hₘ(kₚ_{ᵢ}), so as to obtain a correlation result, and then selects M correlation results for the next statistical operation.

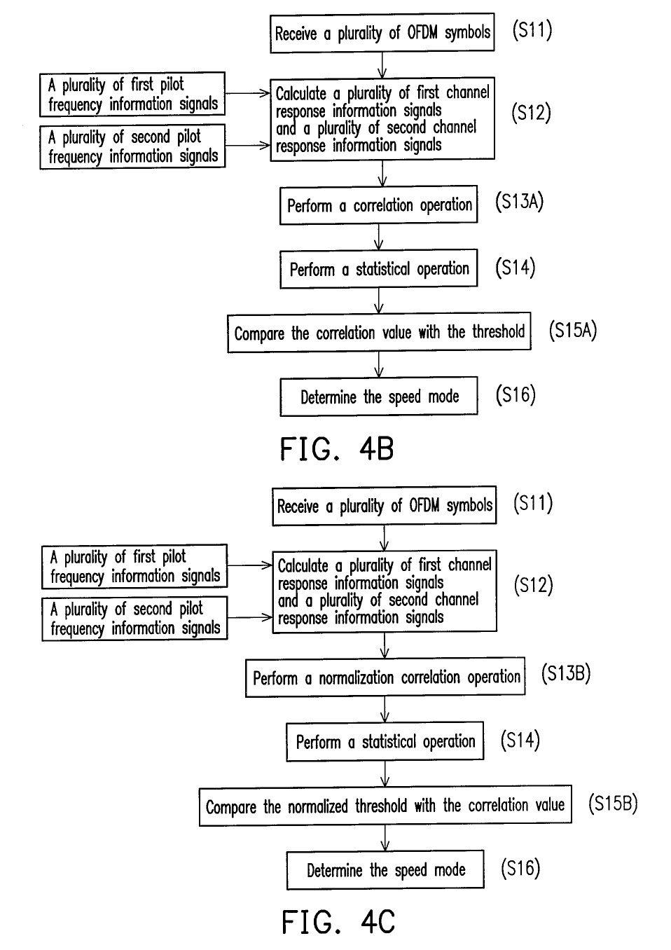

FIG. 4A is a flow chart of a speed estimation method applied in an OFDM system. In Step 401, the sampling interval generator 202 generates a sampling interval l satisfying Θ_{Δt}(l)=J₀(2πfₘₐₓlTₛ), where Tₛ is a length of an OFDM symbol. The time correlation function Θ_{Δt}(l) is set with a threshold. When l makes the time correlation function Θ_{Δt}(l) smaller than the threshold for the first time, the l is considered as an optimal sampling interval. The threshold is set upon a principle for providing the speed estimation result with an optimal estimation range. In this embodiment, the threshold is set as 0.5, the speed threshold υ_{c} for the fast mode and the slow mode is 130 kmph, and the carrier frequency f_{c} of the transmitter is 474 MHz. l is 16 in the 2 k mode, 8 in the 4 k mode, and 4 in the 8 k mode. In addition, the above values of l are sent to the correlator 204 in Step 401.

In Step 403, the channel response information signals Hₘ output by the signal receiving device 102 in FIG. 1 is received. It is an implementation of the present invention to first determine the sampling interval l in Step 401 and then receive the channel response information signals Hₘ in Step 403. However, in other embodiments, the Step 401 of determining the sampling interval can be performed after the Step 403 of receiving the channel response information signals Hₘ, or the two steps are performed at the same time.

In Step 405, the channel response information correlator 204 receives the channel response information signals Hₘ and the sampling interval l, and then performs correlation on two OFDM symbols of the (kₚ_{ᵢ})^{th} sub-carrier, so as to obtain a correlation value. It is considered that the speed impact on different sub-carriers is the same, so the same correlation operation is performed on sampling symbols at the same position and with the same interval of the previous M consecutive sub-carriers. M is the number of the correlation values of the consecutive sub-carriers that can be stored in the correlator.

In Step 407, a statistical operation is performed on the correlation value generated in Step 405 according to

$${\hat{Θ}}_{m} ( l ) = \frac{1}{M} {\sum }_{i = 1}^{M} {\hat{H}}_{m} ( {k}_{{p}_{i}} ) \cdot {\hat{H}}_{m + l}^{*} ( {k}_{{p}_{i}} ) ,$$

so as to obtain the closest time correlation function value. In Step 409, the frequency lock unit 208 performs frequency lock according to the result of the time correlation function statistical operation, so as to obtain an adjusted time correlation function statistical value. In Step 407, the above statistical operation result can also be obtained through an arithmetic mean method.

In Step 410, the comparator 210 compares the adjusted time correlation function statistical value with a threshold. It is considered in the slow mode when the adjusted time correlation function statistical value is larger than the threshold, and in a fast mode when the adjusted time correlation function statistical value is smaller than the threshold. In this embodiment, the threshold is set as 0.5. In other embodiments, the setting of the threshold can be adjusted according to the characteristics of the system.

FIG. 4B is a flow chart showing the steps of a speed mode estimation method applied in an OFDM system according to an embodiment of the present invention. In Step (S11), a plurality of OFDM symbols is received. In Step (S12), a plurality of first channel response information signals are generated according to a plurality of first pilot frequency information signals corresponding to the i^{th} OFDM symbol in the OFDM symbols, and a plurality of second channel response information signals are generated according to a plurality of second pilot frequency information corresponding to the j^{th} OFDM symbol in the OFDM symbols.

In Step (S13A), a correlation operation is performed on the plurality of first and second channel response information signals to generate a correlation value \hat{Θ}ₘ(L). As the above calculated correlation value varies greatly, Step (S14) is adopted to obtain a statistical correlation value Θ̅ₘ(L) after a statistical operation is performed on the above correlation value \hat{Θ}ₘ(L). The statistical operation is an average operation or a second-order filter operation.

In Step (S15A), a correlation value threshold Θ_{TH} is set, and the above statistical correlation value Θ̅ₘ(L) is compared with the correlation value threshold Θ_{TH}, so as to obtain a difference there-between. Afterward, in Step (S16), it is determined based on the difference obtained from Step (S15) whether the status of the channel is in the fast mode or the slow mode.

Further, referring to FIG. 4C, a normalization operation is first performed on the plurality of first channel response information signals and the plurality of second channel response information signals obtained from Step (S12), and then a correlation operation is performed on the normalized first and second channel response information, so as to generate a normalized correlation value \hat{Θ}ₘ₋ₙₒᵣ(L). In Step (S13B), the normalized first and second channel response information signals can be collated into a normalization correlation operation after the correlation operation, and the normalization correlation mathematical expression is shown in FIG. 2C.

In addition, after the normalized correlation value \hat{Θ}ₘ₋ₙₒᵣ(L) goes through Step (S14), a normalized statistical correlation value Θ̅ₘ₋ₙₒᵣ(L) is obtained. Step (S15B) is changed to set a normalized correlation value threshold Θ_{TH-nor}, and compare the normalized statistical correlation value Θ_{TH-nor} with the normalized correlation value threshold Θ_{TH-nor} to obtain a difference there-between. Subsequently, in Step (S16), it is determined based on the difference obtained from Step (S15B) whether the status of the channel information is in the fast mode or the slow mode.

FIG. 5 is a schematic view showing changes of the time correlation function statistical value of a DVB-T in a 2 k mode. The speed of the wireless terminal ranges from 50 kmph to 250 kmph, the threshold is 0.5, the tracking time is 0.2 s, and a quadrature phase-shift keying (QPSK) mode is adopted. The variation range of the statistical value Θ̅ₘ(L) can be seen from the figure.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A speed estimation device applicable to an orthogonal frequency division multiplex (OFDM) system, for receiving a plurality of channel response information signals from an OFDM symbol and obtaining a speed estimation result according to a sampling interval, the speed estimation device comprising:
a correlator, for performing a correlation operation on the plurality of channel response information signals corresponding to sub-carriers with the sampling interval, so as to obtain a plurality of correlation result information signals;
a statistical module, connected to the correlator, for performing a statistical operation on the plurality of correlation result information signals, so as to obtain a statistical correlation result information signal; and
a comparator, connected to the statistical module, for comparing the statistical correlation result information signal with a first threshold, so as to obtain the speed estimation result.

2. The speed estimation device according to claim 1, wherein the speed estimation result is a first or second speed mode, when the statistical correlation result information signal is larger than the first threshold, determining the speed estimation result to be the first speed mode, and when the statistical correlation result information signal is smaller than the first threshold, determining the speed estimation result to be the second speed mode.

3. The speed estimation device according to claim 1, wherein the correlator further comprises a storage for storing the channel response information signals corresponding to m sub-carriers in the correlator, and m is smaller than or equal to the length of the storage.

4. The speed estimation device according to claim 1, wherein the sampling interval is in inverse proportion to a product of a length Tₛ of the OFDM symbol and a maximum Doppler shift.

5. The speed estimation device according to claim 1, wherein the sampling interval makes a time correlation function smaller than a second threshold, and the time correlation function satisfies J₀(2πfₘₐₓlTₛ), wherein l is a duration of the sampling interval, fₘₐₓ is a maximum Doppler shift of the first speed mode, Tₛ is the length of the OFDM symbol, and J₀ is a zero-order Bessel function.

6. The speed estimation device according to claim 1, wherein the maximum Doppler shift is set according to different working modes of a digital TV broadcasting system.

7. The speed estimation device according to claim 1, wherein the plurality of channel response information signals are derived from the information signals of the sub-carriers in the received OFDM symbol and a plurality of corresponding pilot frequency information signals.

8. The speed estimation device according to claim 1, further comprising a normalization processing module, wherein the correlation result information signals are normalized correlation result information signals, the statistical correlation result information signal is a normalized statistical correlation result information signal, and the first threshold is a normalized first threshold.

9. The speed estimation device according to claim 1, wherein the statistical module comprises an averaging device for performing an average operation on the correlation result information signals, and the statistical correlation result information signal is an average value of the correlation result information signals.

10. The speed estimation device according to claim 1, further comprising a filter for filtering the correlation result information signals and outputting the filtered correlation result information signal, and the statistical correlation result information signal is the filtered correlation result information signal.

11. The speed estimation device according to claim 1, wherein the correlation operation is a covariance operation, and the plurality of correlation result information signals are a plurality of covariance result information signals.

12. A speed estimation method applicable to an orthogonal frequency division multiplex (OFDM) system, for receiving a plurality of channel response information signals and obtaining a speed estimation result according to a sampling interval, the speed estimation method comprising:
performing a correlation operation on two sub-carriers selected with the sampling interval, so as to obtain a plurality of correlation result information signals;
performing a statistical operation on the plurality of correlation result information signals, so as to obtain a statistical correlation result information signal; and
comparing the statistical correlation result information signal with a first threshold, so as to obtain the speed estimation result.

13. The speed estimation method according to claim 12, wherein the step of generating the speed estimation result further comprises:
when the statistical correlation result information signal is larger than the first threshold, determining the speed estimation result to be a first speed mode and when the statistical correlation result information signal is smaller than the first threshold, determining the speed estimation result to be a second speed mode.

14. The speed estimation method according to claim 12, wherein the sampling interval is in inverse proportion to a product of a length Tₛ of the OFDM symbol and a maximum Doppler shift.

15. The speed estimation method according to claim 12, wherein the sampling interval makes a time correlation function smaller than a second threshold, and the time correlation function satisfies J₀(2πfₘₐₓlTₛ), wherein l is a duration of the sampling interval, fₘₐₓ is a maximum Doppler shift of the first speed mode, Tₛ is the length of the OFDM symbol, and J₀ is a zeroth-order Bessel function.

16. The speed estimation method according to claim 12, wherein the sampling interval is set according to different working modes of a digital TV broadcasting system.

17. The speed estimation method according to claim 12, wherein the plurality of channel response information signals are derived from the information of the two sub-carriers in the received OFDM symbol and a plurality of corresponding pilot frequency information signals.

18. The speed estimation method according to claim 12, further comprising performing a normalization processing, so as to obtain normalized correlation result information signals from the correlation result information signals and a normalized statistical correlation result information signal from the statistical correlation result information signal, and set the first threshold to be a normalized first threshold.

19. The speed estimation method according to claim 12, wherein the statistical operation is an averaging operation performed on the correlation result information signals, and the statistical correlation result information signal is an average value of the correlation result information signals.

20. The speed estimation method according to claim 12, further comprising filtering the correlation result information signals and outputting a filtered correlation result information signal, and the statistical correlation result information signal is the filtered correlation result information signal.

21. The speed estimation method according to claim 12, wherein the correlation operation is a covariance operation, and the plurality of correlation result information signals are a plurality of covariance result information signals.

22. An orthogonal frequency division multiplex (OFDM) receiver, comprising:
a signal receiving device, for receiving a plurality of OFDM symbols and performing frequency compensation on the plurality of OFDM symbols, so as to output a plurality of channel response information signals;
a speed estimation device, for receiving the plurality of channel response information signals output by the signal receiving device, and performing speed estimation according to a sampling interval, so as to output a speed estimation result; and
a channel estimation device, connected to the speed estimation device, for receiving the speed estimation result and completing the channel estimation.

23. The receiver according to claim 22, wherein the speed estimation device further comprises:
a correlator, for performing a correlation operation on the plurality of channel response information signals corresponding to sub-carriers with the sampling interval, so as to obtain a plurality of correlation result information signals;
a statistical module, connected to the correlator, for performing a statistical operation on the plurality of correlation result information signals, so as to obtain a statistical correlation result information signal; and
a comparator, connected to the statistical module, for comparing the statistical correlation result information signal with a first threshold according to the first threshold, so as to obtain a speed estimation result.
